(19) United States
(12) Patent Application Publication
(10) Pub. No.: US 2011/0204098 A1
(43) Pub. Date: Aug. 25, 2011

(54) Cap construction allows inline fluid flow

(76) Inventor: Taiming Chen, Fremont, CA (US)

(21) Appl. No.: 12/802,270

(22) Filed: Jun. 4, 2010

Related U.S. Application Data
(60) Provisional application No. 61/338,412, filed on Feb. 19, 2010.

(51) Int. Cl. B67D 3/00

(52) U.S. Cl. 222/519

(57) ABSTRACT

A container cap closure having a cap portion, container portion and retaining means. Said cap portion has sleeve shell, a central plug, inline fluid passage and retaining means. At container outlet portion there is seat ring on bore edge so to align with said cap plug. Said retaining means is for releasably fastening said cap portion and container outlet portion, to maintain a determined distant from tight seal to a certain opening between said plug and seat ring.

### CROSS-REFERENCE TO RELATED APPLICATIONS

This application is related to and claims priority from U.S. Provisional Patent Application Ser. No. 61/338,412 filed on Feb. 19, 2010. The content of the Application is incorporated into present invention as a part of the specification.

### FIELD OF THE INVENTION

This invention intends to provide a cap construction with inline valve function for fluid container, to release stop or regulate the flow of out going fluid while pressure may be already on.

### BACKGROUND

Container cap have been provided to be operated the best while fluid is not under pressure to go out of container. Normally there is a clear transition state of cap removed but fluid is not under pressure to leave a container (because of position of outlet). Then there is an action of pour (change outlet's position). Current cap doesn't provide a controllable release, stop or regulate fluid flow while fluid is already under pressure to leave container.

### BRIEF SUMMARY OF THE INVENTION

The present invention provides a cap construction with an outer shell for user to hold on and to control, a central plug within said shell to stop or regulate fluid when aligning and making close contact with seat ring of container outlet portion. When said plug departed from said seat ring, fluid is able to flow out and pass through inline fluid passage within said shell. This invention can be used where fluid is already under pressure to come out of container such as liquid container with lower outlet position. It can be simple replacement for inline valve/faucet; or to release carbonated liquid from a lower outlet while keeping high pressure gas at top of container to maintain the carbonated fizz until it is mostly consumed. (FIG. 4).

### BRIEF DESCRIPTION OF THE DRAWINGS

FIG. 1: A section view along vertical central line shows cap construction makes tight seal with container outlet. Cap plug 21 is having close contact with seat ring 12 of container outlet bore.

FIG. 2: A section view of cap construction along the outlet opening surface, it shows outer shell 20, central plug 21 and fluid passage 22.

FIG. 3: A section view shows cap construction had departed from container outlet. Cap plug 21 is keeping a distance from seat ring 12 of container. Fluid 11 is flowing out of container through passages 22.

FIG. 4: Shows a bottle of fluid is being poured while outlet portion is at lower position.

### DETAILED DESCRIPTION OF THE PREFERRED EMBODIMENT

Prior to the more detailed description of the present invention, it should be noted that, for the sake of clarity and understanding, identical components which have identical functions have been identified with identical reference numerals throughout the several views illustrated in the drawing figures.

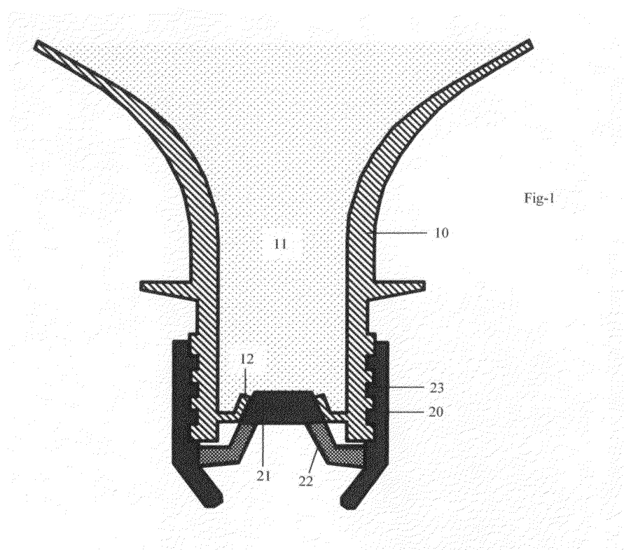

The cap construction 20 as show in FIG. 1 is claming on outlet of a container 10 by tightening along screw thread 23. A central plug 21 is pushing against seat ring 12 of container to form a tight seal. Liquid 11 inside container 10 can not exit out through this outlet.

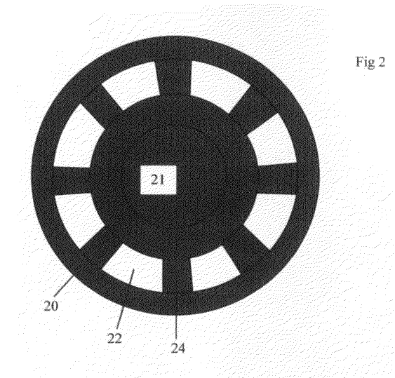

As shown in FIG. 2, Central plug 21 is connecting to outer shell 20 through spokes 24 and there are passages 22 for fluid in between of them.

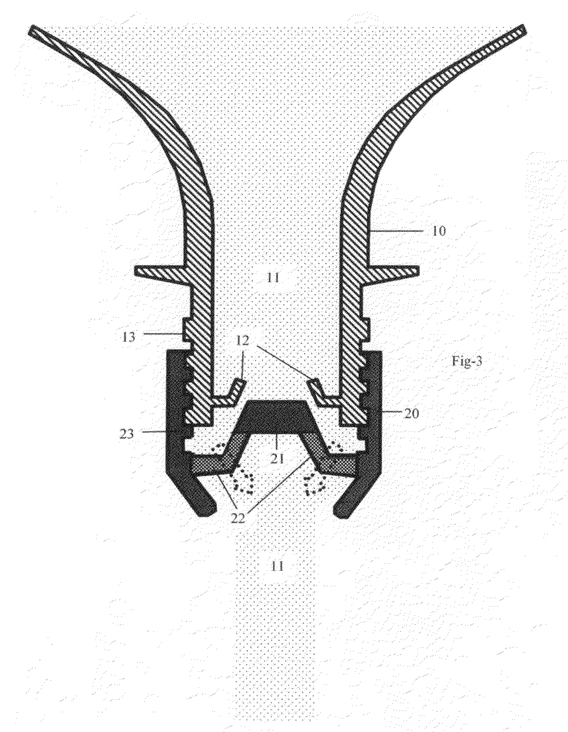

When cap 20 looses its tight seal against seat ring 12 as in FIG. 3, Liquid 11 is able to flow through gap in between plug 21 and seat ring 12, and through the passages 22 in between spokes 24. Therefore there is no need to completely remove cap 20 from outlet 10 and the outer shell 20 of cap would not be in the way of liquid 11.

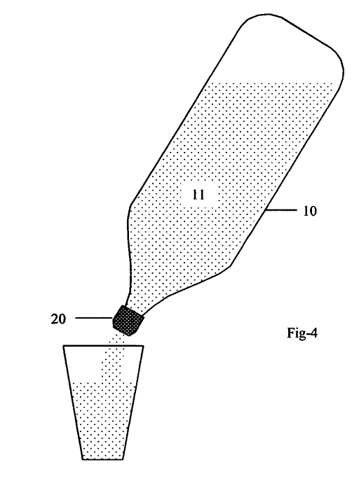

FIG. 4 shows a container 10 is pouring liquid 11 with cap 20 still attached.

1. This present invention concerns a container cap closure having
(a) a cap portion with sleeve shell, a central plug and inline fluid passage, retaining means,
(b) a container outlet portion with seat ring on bore edge so to align with said plug, and
(c) retaining means for releasably fastening said cap portion and container outlet portion, to maintain a determined distant from tight seal to a certain opening between said plug and seat ring.

2. The container cap closure of claim 1, wherein: said retaining means are screw threads on both cap construction and container outlet portions so as cap construction rotatively travels along the screw track to get apart from or close to container outlet portion.

3. The container cap closure of claim 1, wherein: said retaining means can control the gaping distance between said plug of cap portion and said seat ring of container portion so as to regulate the fluid out going rate.

4. The container cap closure of claim 1, wherein: said retaining means can completely disengage to separate said cap portion and said container portion so as to leave outlet portion completely unblocked.
